(19) United States
(12) Patent Application Publication
(10) Pub. No.: US 2015/0021925 A1
(43) Pub. Date: Jan. 22, 2015

(54) METHOD TO CONTROL TEMPERATURE OF ENGINE OF GENERATOR SYSTEM

(71) Applicant: Caterpillar Inc., Peoria, IL (US)

(72) Inventors: Robert M. Stengl, Locust Grove, GA (US); Anis Ahmed, Fayetteville, GA (US)

(73) Assignee: Caterpillar Inc., Peoria, IL (US)

(21) Appl. No.: 14/510,137

(22) Filed: Oct. 9, 2014

(51) Int. Cl. F02B 63/04; G01M 15/05; F02D 35/02

(52) U.S. Cl. CPC F02B 63/04; F02D 35/02; G01M 15/05
USPC 290/40 C; 73/114.01

(57) ABSTRACT

A method to control temperature of an engine of a generator system during a load test is provided. The generator system includes a generator, one of a liquid load bank and an air resistive load bank, a reversible fan, and a heat exchanger. The method includes heating of the engine to a pre-determined temperature with heat supplied by the liquid load bank and the reversible fan or by the air resistive load bank via the reversible fan.

### TECHNICAL FIELD

The present disclosure relates generally to generator systems. More specifically, the present disclosure relates to a method to control temperature of engine of the generator system.

### BACKGROUND

A standby generator system provides backup power in the event that the main power service for a facility fails. The standby generator system may produce power over a power bus when there is an electrical failure. The facility will continue to have power despite the electrical failure when the backup power is provided over the power bus. The standby generator system may further be used to supplement the power on the power bus during periods of peak demand in applications such as a manufacturing plant.

Typically, a generator system includes a combination of a generator and a prime mover (such as an engine). A mixture of fuel and air may be combusted within the engine to create a mechanical rotation of engine crankshaft, which drives the generator to produce electrical power. Ideally, the engine may drive the generator with a relatively constant torque and speed. Accordingly, the generator may produce electrical power output with relatively constant characteristics. However, at times, the generator systems may fail to start or perform as desired in the time of need. Hence, the generator system may require frequent maintenance. Most maintenance is preventive in nature, to assure reliability of the generator systems. Preventive maintenance is typically done on a routine schedule based upon engine operation hours. The preventive maintenance may be performed by use of load bank testing. A load bank may be provided to deliver an additional controlled load that brings the engine to an acceptable operating temperature to ensure functionality. However, at times, the generator system may operate in under-load conditions. During such conditions, the engine may not attain the optimum operating temperature. Hence, over time, “slobbering” of the generator systems may be a problem encountered, when the generator system is lightly loaded. Slobber is a result of lubricating oil being drawn into the cylinder under low load conditions. Another problem encountered in the generator systems may be condensation resulting from humidity, unless the generator systems are fully enclosed. Temperature rise of the generator system and the circulation of cooling air with sufficient load operation may prevent condensation. The above-mentioned problems are not conducive to long life and good performance of the generator systems.

Japanese Patent No. 61,210,229 discloses a generator system, which includes a generator, an engine, a radiator, a fan, and an electric heating resistor. The electric heating resistor is automatically connected to the generator during low load running of the engine. The fan operates in conjunction with the radiator to cool the engine. However, there is no solution disclosed to avoid wet-stacking or engine slobber, while the generator system is under load bank testing.

### SUMMARY OF THE INVENTION

The present disclosure relates to a method for controlling temperature of an engine of a generator system during a load test.

In accordance with one aspect of the present disclosure, the generator system includes the engine, a generator, a liquid load bank, a reversible fan, and a heat exchanger. The engine includes an engine jacket. The method includes generation of heat from the liquid load bank through an electrical connection with the generator in response to initiation of the load test. A flow of heated coolant from the load bank is directed to the engine jacket. Further, heat generated in the heat exchanger is directed to the engine by the reversible fan. Thus, the heat transferred to the engine is augmented and an engine jacket temperature is maintained at a pre-determined temperature.

In accordance with another aspect of the present disclosure, the generator system includes the engine, a generator, a liquid load bank, a reversible fan, and a heat exchanger. The method includes generation of heat from the air resistive load bank through an electrical connection with the generator, in response to initiation of the load test. The ambient air is delivered to the air resistive load bank to cool the air resistive load bank. Thus, the ambient air, which flows through the air resistive load bank, is heated. The heat exchanger is pre-heated by the air resistive load bank, via flow of heated ambient air. Further, the heat from the heat exchanger is delivered to the engine via the reversible fan. The engine jacket temperature is maintained at a pre-determined temperature during the load test.

### BRIEF DESCRIPTION OF THE DRAWINGS

FIG. 1 illustrates a schematic of a first generator system, in accordance with the concepts of the present disclosure;

FIG. 2 illustrates a schematic of a second generator system, in accordance with the concepts of the present disclosure;

FIG. 3 illustrates a flowchart for a method to control temperature of an engine of the first generator system of FIG. 1, in accordance with the concepts of the present disclosure; and

FIG. 4 illustrates a flowchart for a method to control temperature of the engine of the second generator system of FIG. 2, in accordance with the concepts of the present disclosure.

### DETAILED DESCRIPTION

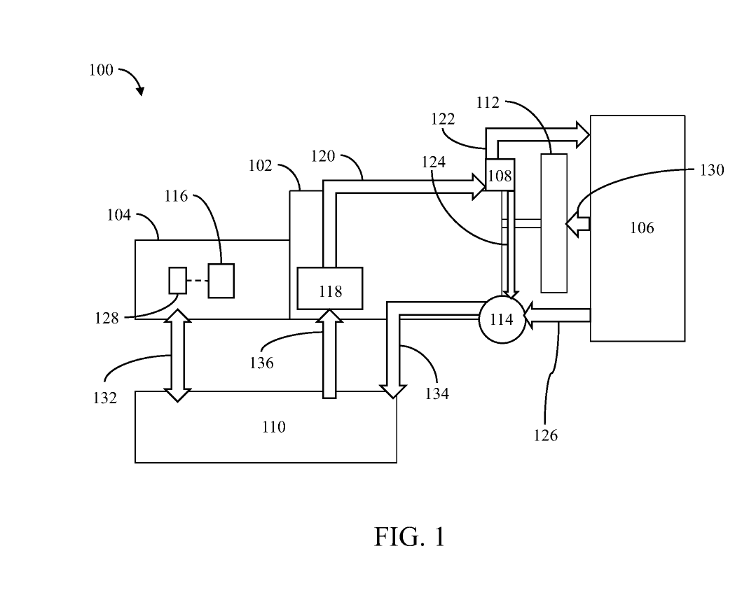

Referring to FIG. 1, there is shown a first generator system 100. The first generator system 100 includes an engine 102, a generator 104, a heat exchanger 106, a thermostat 108, a liquid load bank 110, a reversible fan 112, a pump 114, and a controller 116. Further, the engine 102 may be any type of combustion engine, such as a diesel engine, a gasoline engine, or a gaseous fuel-powered engine. The engine 102 includes an engine jacket 118. The engine jacket 118 is a water-cooled jacket, which is defined as the coolant flow path within the engine 102 passing through components such as, an engine block, a cylinder head, an oil cooler (engine/transmission), an exhaust gas recirculation system, and the like, to allow cooling of the engine components. The engine 102 is adapted to combust a mixture of fuel and air to produce mechanical power. The engine 102 is operatively coupled to the generator 104. Examples of the generator 104 may be an alternating current (AC) induction generator, a permanent-magnet generator, an AC synchronous generator, or a switched-reluctance generator. The generator 104 is configured to receive the mechanical power produced by the engine 102, and converts into electrical power. The electrical power produced by the generator 104 may be directed for off-board purposes by one or more generator bus bars (not shown).

The engine jacket 118 is configured to allow coolant to flow therein. The coolant is delivered to the engine jacket 118 by the pump 114. Further, the engine coolant is in fluid communication with the thermostat 108. The fluid communication between the engine 102 and the thermostat 108 is depicted by arrow 120. The coolant temperature increases as the coolant cools the engine 102 and flows to the thermostat 108. The thermostat 108 is configured to sense temperature of the heated coolant that exits the engine jacket 118. The thermostat 108 is in fluid communication with the heat exchanger 106 and the pump 114. The thermostat 108 allows flow of the heated coolant to the heat exchanger 106, when the temperature of the heated coolant is above a pre-determined temperature; else it allows the coolant to bi-pass the heat exchanger 106 and flows directly to the pump 114. The flow of the heated coolant from the thermostat 108 to the heat exchanger 106 is shown as arrow 122. The fluid communication between the thermostat 108 and the pump 114 is shown as arrow 124.

The heat exchanger 106, which is positioned downstream of the thermostat 108 and the engine 102, is configured to reduce the temperature of the heated coolant. The heat exchanger 106 may include fins or tubes to allow flow of the heated coolant therewithin. In an embodiment of the invention, the heated coolant is then cooled in the heat exchanger 106 when the ambient air passes through the heat exchanger 106. The ambient air may be delivered to the heat exchanger 106, via the reversible fan 112, coupled to the engine 102. In the current embodiment, the reversible fan 112 is positioned between the engine 102 and the heat exchanger 106. The reversible fan 112 may be actuated by an external source (not shown). The ambient air passes through the heat exchanger 106. The ambient air may become heated during the process of cooling the heated coolant in the heat exchanger 106. The heated ambient air from the heat exchanger 106 is sucked by the reversible fan 112 and pushed towards the engine 102. The flow of the ambient air from the heat exchanger 106 to the reversible fan 112 is depicted by arrow 130.

Once cooled, the coolant is directed from the heat exchanger 106 to the pump 114. The flow of the cooled coolant from the heat exchanger 106 to the pump 114 is shown by arrow 126. The pump 114 may be in fluid communication with the liquid load bank 110.

Further, the generator 104 includes the controller 116 and a switch 128. The controller 116 may include a processor (not shown) and a memory component (not shown). The controller 116 may execute a discrete algorithm for generation of one or more signals of the generator 104, which are indicative of a desired frequency or a desired engine speed. The switch 128 may be a toggle switch, which is adapted to control the liquid load bank 110. The liquid load bank 110 may include components that are electrically conductive. The liquid load bank 110 is in electrical communication with the generator 104. The generator 104, via an electrical connection 132, powers the liquid load bank 110. The power is delivered to the liquid load bank 110, based on the signal from the controller 116. Once powered, the liquid load bank 110 is heated due to heating of electrically conductive material. The liquid load bank 110 produces thermal load, which is applied to the engine 102.

As discussed above, the liquid load bank 110 is in fluid communication with the pump 114. The pump 114 delivers the cooled coolant to the heated liquid load bank 110, to cool the liquid load bank 110. The fluid communication between the pump 114 and the liquid load bank 110 is depicted by arrow 134. As the coolant cools the liquid load bank 110, the coolant gets heated up. The pre-heated coolant then flows to the engine jacket 118. The flowing coolant heats the engine jacket 118 to a pre-determined temperature. The pre-determined temperature may be defined as the temperature at which the engine 102 is to be maintained to prevent engine slobber. The fluid communication of the heated coolant from the liquid load bank 110 to the engine jacket 118 is depicted by arrow 136.

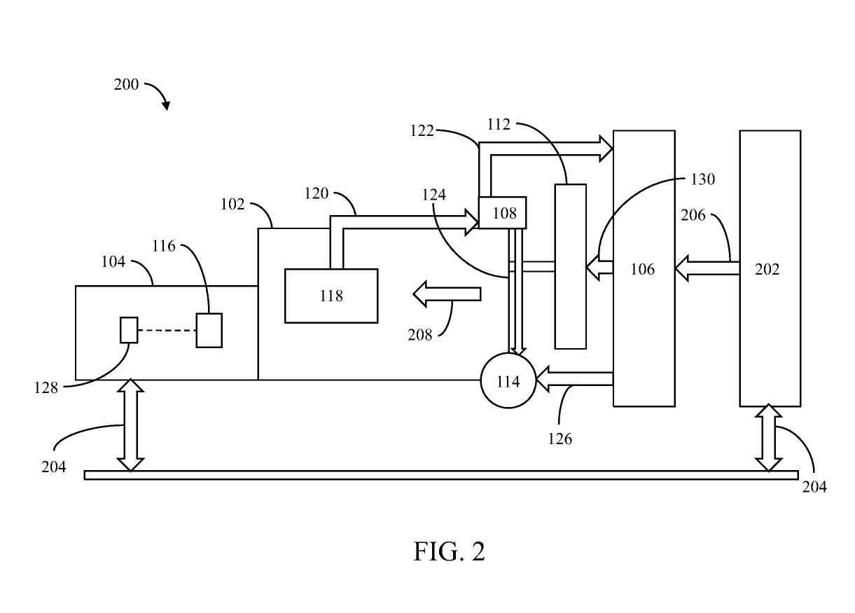

Referring to FIG. 2, there is shown a second generator system 200. In addition to the elements, such as the engine 102, the generator 104, the heat exchanger 106, the thermostat 108, the reversible fan 112, the pump 114, and the controller 116, the second generator system 200 includes an air resistive load bank 202. The structure and function of the second generator system 200 is similar to that of the first generator system 100. The air resistive load bank 202 is positioned downstream from the heat exchanger 106. The air resistive load bank 202 is in electrical communication with the generator 104. This implies that the generator 104 provides power to the air resistive load bank 202. Power is supplied via an electrical connection 204 and is based on the signal generated by the controller 116. The air resistive load bank 202 is heated and produces the electrical load to pre-heat the engine 102. The ambient air gets heated while the air resistive load bank 202 is cooled. The heated ambient air is then navigated to the heat exchanger 106. The flow of the heated ambient air from the air resistive load bank 202 to the heat exchanger 106 is depicted by arrow 206. The heated ambient air flowing through the heat exchanger 106 is sucked by the reversible fan 112. The flow of the heated ambient air from the heat exchanger 106 to the reversible fan 112 is depicted by the arrow 130. The reversible fan 112, then supplies the sucked ambient air to the engine enclosure around the engine 102. The flow of the sucked ambient air from the reversible fan 112 to the engine 102 is depicted by arrow 208.

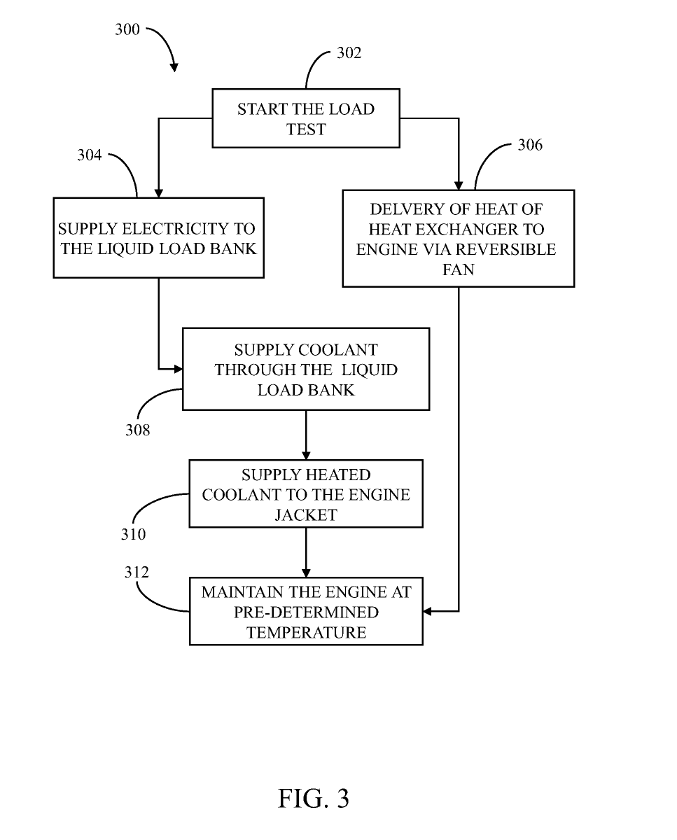

Referring to FIG. 3, there is shown a flowchart 300 that illustrates a method to control the temperature of the engine 102 in the first generator system 100. The method starts with step 302.

At step 302, the switch 128 is actuated to start a load test, based on a maintenance schedule. The method simultaneously proceeds to step 304 and step 306.

At step 304, the actuation of the switch 128 initiates the flow of electricity from the generator 104 to the liquid load bank 110. The liquid load bank 110 is heated while producing the electrical load. The method proceeds to step 308.

At step 306, the reversible fan 112 begins to rotate in the opposite direction to suck the heated ambient air away from the heat exchanger 106 and towards the engine 102. The method proceeds to step 312.

At step 308, the liquid load bank 110 is cooled by the cooled coolant supplied by the pump 114 to the liquid load bank 110. The method proceeds to step 310.

At step 310, as the liquid load bank 110 is cooled, the coolant becomes heated. The coolant is pre-heated and then supplied to the engine jacket 118. The method proceeds to end step 312.

At end step 312, the engine 102 is maintained at the pre-determined temperature. The pre-determined temperature is maintained due to the combined heat from the heated coolant supplied via the liquid load bank 110 and the heated ambient air supplied by the reversible fan 112.

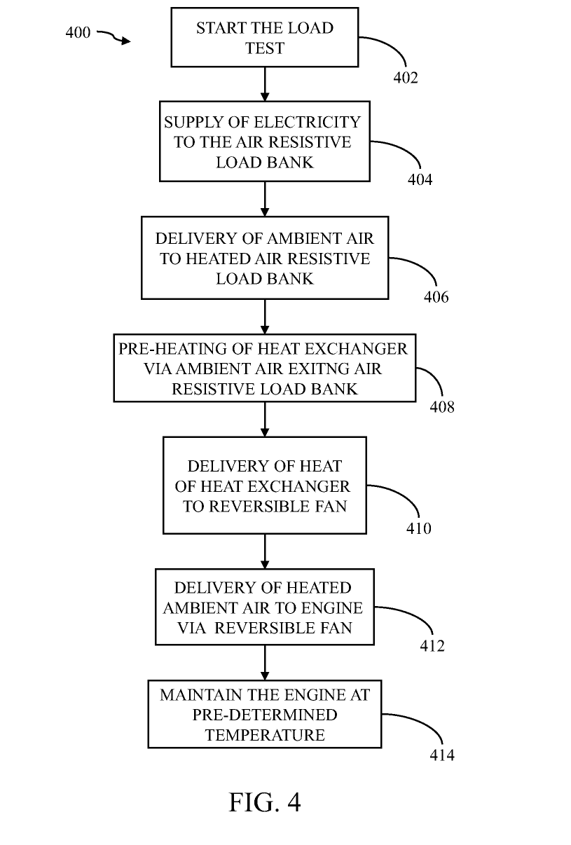

Referring to FIG. 4, there is shown a flowchart 400 for a method to control temperature of the engine 102 in the second generator system 200. The method starts with step 402.

At step 402, the switch 128 is actuated to start load test, based on a maintenance schedule. The method proceeds to step 404.

At step 404, the actuation of the switch 128 initiates the flow of electricity from the generator 104 to the air resistive load bank 202. The air resistive load bank 202 is heated while producing the electrical load. The method proceeds to step 406.

At step 406, the ambient air is delivered to the air resistive load bank 202 to be cooled. The ambient air may be provided by an additional fan or other external source. The method proceeds to step 408.

At step 408, the ambient air is heated while it passes through the air resistive load bank 202. The heated ambient air flows to the heat exchanger 106 and pre-heats the heat exchanger 106. The method proceeds to step 410.

At step 410, the reversible fan 112 sucks the heated ambient air that passes through the pre-heated heat exchanger 106. The reversible fan 112 rotates in a direction so as to direct the flow towards the engine 102. The method proceeds to step 412.

At step 412, the heated ambient air sucked away by the reversible fan 112 and is directed towards the engine 102. The method proceeds to end step 414.

At end step 414, the engine 102 is maintained at the pre-determined temperature. The pre-determined temperature is maintained due to the heat supplied from the heated ambient air supplied by the reversible fan 112.

It will be understood that a combination of the first generator system 100 and the second generator system 200 may also be possible. Specifically, the present disclosure contemplates the management of cooling flow such as, for example, cooling flow subjected to heat transfer from air resistive load bank 202 and liquid load bank 110, which when combined, may be used to maintain the engine 102 at the pre-determined temperature.

### INDUSTRIAL APPLICABILITY

In operation, when the first generator system 100 is operated for the load test, the controller 116 generates the signal that corresponds to the optimum exhaust temperature needed to prevent exhaust slobber. The generator 104 supplies electricity to the liquid load bank 110 based on the signal. The liquid load bank 110 is heated and is cooled by the coolant supplied via the pump 114. Upon cooling the liquid load bank 110, the coolant is heated. The heated coolant is supplied to the engine jacket 118 to heat the engine 102 to prevent exhaust slobber. In addition, the heated air of the heat exchanger 106 is sucked towards engine 102 by the reversible fan 112. Thus, the engine 102 is heated due to the heat provided by the heated coolant via the liquid load bank 110. Simultaneously, the heated ambient air is supplied by the reversible fan 112 and the engine 102 is maintained at the pre-determined temperature. The engine 102 is maintained at the pre-determined temperature to avoid wet-stacking of exhaust gases.

Similarly, when the second generator system 200 is operated for the load test, the controller 116 generates the signal that corresponds to the optimum exhaust temperature to prevent exhaust slobber. The generator 104 supplies electricity to the air resistive load bank 202, based on the signal. The air resistive load bank 202 is then cooled by the ambient air, which flows through the air resistive load bank 202. Upon cooling the air resistive load bank 202, the ambient air is heated. The heated ambient air then flows to the heat exchanger 106, thereby pre-heating the heat exchanger 106. The ambient air that passes through the heat exchanger 106 is then heated and sucked away by the reversible fan 112. The reversible fan 112 then directs the heated ambient air to the engine 102, thereby heating the engine 102. Thus, due to the heat provided by the heated ambient air supplied by the reversible fan 112, the engine 102 is maintained at the pre-determined temperature.

The disclosed methods are directed at prevention of wet-stacking and engine slobbering, during the load test of the generator systems 100 and 200. The methods utilize the algorithm, which is executed to provide optimum exhaust conditions for complete combustion of the fuel in the engine 102. The liquid load bank 110 and the air resistive load bank 202 are heated in accordance with the algorithm. The disclosed method uses the waste heats of the liquid load bank 110 and the air resistive load bank 202 to heat the engine 102 and maintain the engine 102 at the optimum operational temperature. The current methods and system may be inefficient due to occurrence of slobbering and incomplete combustion of fuels during the no-load test or low-load test.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method for controlling temperature of an engine of a generator system during a load test, the generator system including the engine, a generator, a liquid load bank, a reversible fan, and a heat exchanger, wherein the engine includes an engine jacket, the method comprising:
generating heat from the liquid load bank through an electrical connection with the generator in response to initiation of the load test;
directing a flow of heated coolant from the load bank, to the engine jacket;
directing heat generated from the heat exchanger to the engine by way of the reversible fan to augment engine heat generated from the liquid load bank; and
maintaining an engine jacket temperature at a predetermined temperature.

2. A method for controlling temperature of an engine of a generator system during a load test, the generator system including the engine, a generator, an air resistive load bank, a reversible fan, and a heat exchanger, the method comprising:
generating heat from the air resistive load bank through an electrical connection with the generator in response to initiation of the load test;
delivering ambient air to the air resistive load bank to cool the air resistive load bank, thereby heating the ambient air flowing through the air resistive load bank;
pre-heating the heat exchanger by delivering heat of the air resistive load bank, via flow of heated ambient air; and
delivering heat from the heat exchanger to the engine, via the reversible fan and to maintain an engine jacket temperature at a predetermined temperature during the load test.

3. Method of claim 1, includes pre-heating of coolant passing through the engine jacket, by extracting heat from the liquid resistive load bank.
